(19) United States
(12) Patent Application Publication
(10) Pub. No.: US 2008/0013273 A1
(43) Pub. Date: Jan. 17, 2008

(54) Computer chassis having a tuning gasket

(75) Inventors: Mark M. Bailey, Burnet, TX (US); Steven J. Zielnicki, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/486,623

(22) Filed: Jul. 14, 2006

(51) Int. Cl. G06F 1/16

(52) U.S. Cl. 361/685

(57) ABSTRACT

A chassis is disclosed that includes a sidewall having an aperture and a gasket connected to the sidewall. A portion of the gasket protrudes through the aperture into a bay. A carrier may couple with the chassis such that the gasket touches the carrier. The gasket may discharge electrostatic buildup of the carrier and/or exert force on the carrier, such that the carrier resists movement.

### TECHNICAL FIELD

The present disclosure relates generally to computer systems and information handling systems, and, more particularly, to a tuning gasket for hard drive carrier for a computer system or information handling system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system or computer system may include a hard drive that is coupled to the chassis of a computer or a drive bay. A hard drive is typically disposed on a carrier assembly, often referred to as a hard drive carrier, and the carrier assembly is inserted, via a guide rail system, into a bay in a computer chassis. The hard drive carrier serves as a protective housing for the hard drive and mechanically mates with a drive bay in a computer chassis.

### SUMMARY

In accordance with the present disclosure, a chassis is disclosed that includes a sidewall and a gasket. The sidewall may have an aperture, and the gasket may connect to the sidewall such that a portion of the gasket protrudes through the sidewall. An additional gasket may be included on another sidewall. The gaskets may discharge electrostatic buildup of an electronic device installed in the chassis. The gaskets may additionally or alternatively exert a force on an electronic device installed in the chassis.

The chassis disclosed herein is technically advantageous because the gaskets can make electrical contact with a carrier and with the chassis, providing a ground path between the carrier and the chassis, assisting in electromagnetic interference containment.

Another technical advantage is that the gaskets can exert a force on the carrier. This force may cause any potential vibrations of an electronic device within the carrier to be reduced or dampened. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a pictorial view of one embodiment of a tuning gasket;

FIG. 2 is a pictorial view of one embodiment of a chassis having a tuning gasket; and

FIG. 3 is a front view of one embodiment a carrier having a tuning gasket.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suikeyle device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

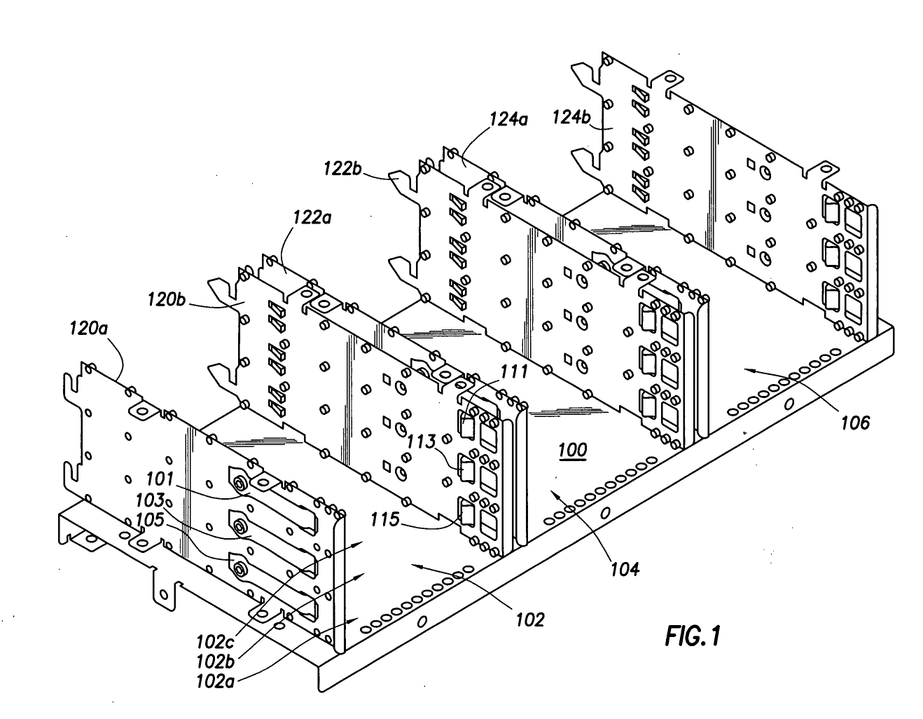

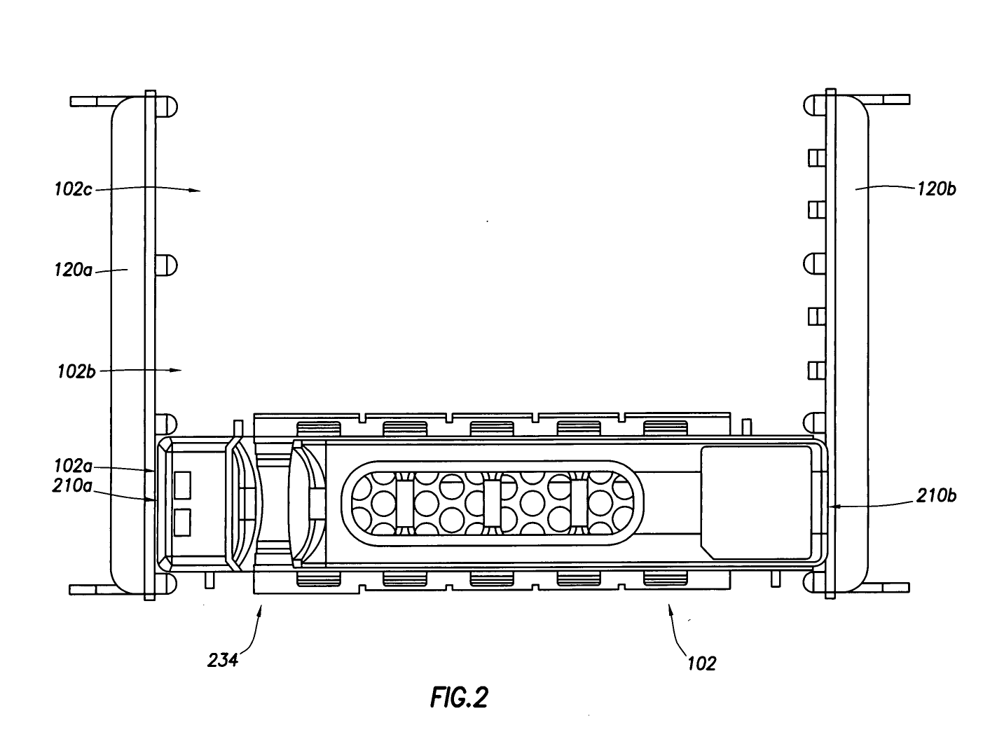

Referring to FIG. 1, chassis 100 includes a plurality of openings 102, 104, 106. Each opening 102, 104, 106 has a pair of sidewalls 120a, 120b, 122a, 122b, 124a, 124b. The sidewalls 120a, 120b cooperate to provide a plurality of bays 102a, 102b, 102c (shown in FIG. 2) within the opening 102 for a carrier such as carrier 234 in bay 102a. Likewise, the sidewalls 122a, 122b and the sidewalls 124a, 124b cooperate to provide bays in the openings 104, 106 respectively, for other carriers (not shown).

Chassis 100 includes gaskets 101, 103, 105, 111, 113, 115 for each of bays 102a, 102b, 102c, respectively. In one embodiment, gaskets 101, 103 and 105 provide static discharge of an electronic device as it is installed in the respective bay, and gaskets 111, 113, 115 provide a grounding contact for electronic devices installed in the respective bays. Gaskets 101, 103, 105, 111, 113, 115 mate with sidewalls 120a, 120b. For example, gaskets 101, 111 protrude through apertures in sidewall 120a. Gaskets 105 and 115 may be secured to sidewalls 120a and 120b and may bear some of the weight of an electronic device and carrier when such are installed in bay 102a. When an electronic device carrier is installed in bay 102a, a metal contact initially touches gaskets 105 and 115 to provide a discharge of electrostatic buildup and/or to provide an electrical ground connection. In other words, the gaskets 105, 115 provide electromagnetic interference contact between the chassis 100 and the carrier 234. Additionally, the gaskets 105, 115 apply force on the carrier 234, which may dampens the carrier's fit into the chassis 100. Since there is a gasket on each side of the carrier 234, the carrier 234 may become suspended between the gaskets and held in place.

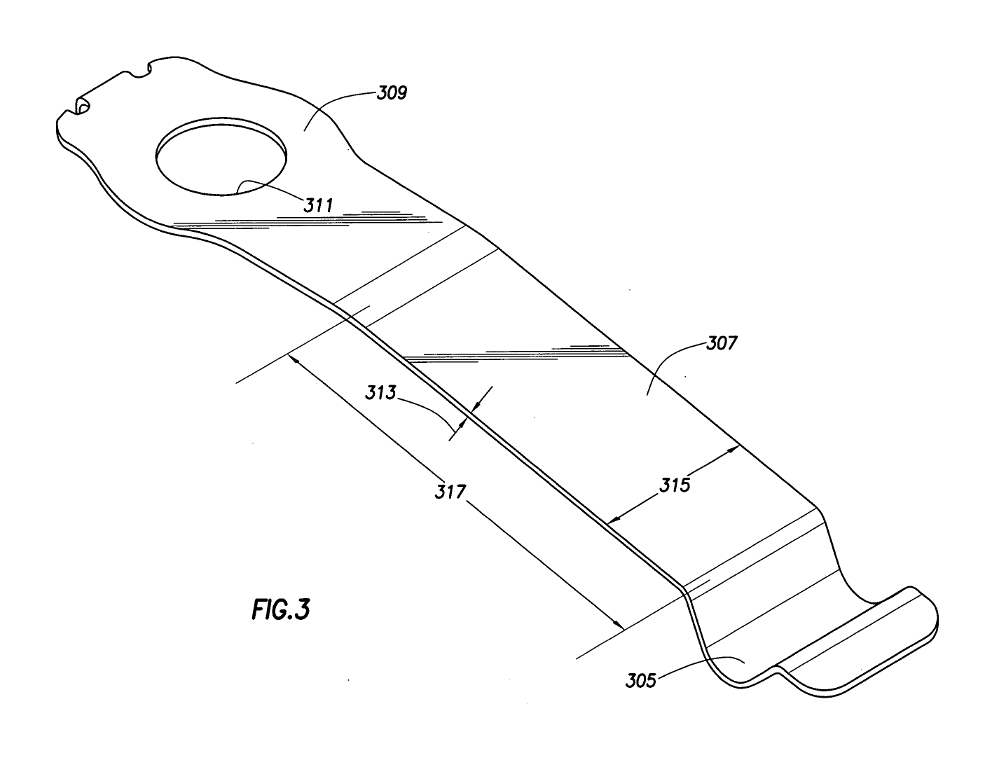

Referring to FIG. 3, a close-up view of one of gaskets 101, 103, 105, 111, 113, 115 is shown. By varying the geometry of the gasket, the force applied can be varied. This varies the spring rate of the carrier 234 in the chassis 100, allowing each specific chassis to be “tuned” by modifying the gasket. This allows for optimized rotational vibration performance. The gasket may be formed from a sheet of metal, which is formed into the required shape; that is, it is deflected from the plane of the sheet metal in a curved fashion so that it can contact an electronic device to discharge and ground it and so that it can securely attach to a sidewall upon which the gasket is placed. The result is a feature which is very strong, precise in dimension, can be adapted for the specific chassis and the specific device, and is easily manufactured. Furthermore, by eliminating several different features and encompassing them all into one easily manufactured design, there are fewer features to be measured, fewer items that can become damaged, and a resulting savings in cost during manufacturing.

The gasket has a protruding portion 305 and an anchor portion 309 separated by an arm portion 307. The gasket may be attached to the sidewall via the anchor portion 309. The protruding portion 305 extends out of a plane created by the arm portion 307, such that it may protrude through a sidewall. As shown in FIG. 3, the anchor portion 309 has a hole 311, through which a fastener may pass. The fastener may connect the gasket to the sidewall such that the protruding portion 305 extends through an aperture in the sidewall, as shown in FIG. 1. The fastener may be a screw, a nut and bolt, or any other suitable connector. Additionally, alternatives to a hole 311 and fastener may be used. For example, the anchor portion 309 may be connected to the sidewall via weld, glue, or any number of other methods, so long as the anchor portion 309 may be secured to the sidewall with the protruding portion 305 extending through a portion of the sidewall.

As the carrier is installed into the bay, the protruding portion 305 of the gasket is pushed away from the carrier. Since the anchor portion 309 is secured to the sidewall, the gasket bends or deflects to allow this. More specifically, the protruding portion 305 moves relative to the anchor portion 309. This deflection causes the protruding portion 305 to exert a contact force 210 (shown in FIG. 2) on the carrier. Depending on the specific characteristics of the gasket, this countering force 210 will vary. For example, if the gasket has a thickness 313 and a width 315 that are large, then it may tend to have a larger countering force 210 than a similarly shaped gasket with a small thickness 313 and width 315. Additionally, a stiff gasket may have a larger countering force 210 than a similarly shaped flexible gasket. The shape of the gasket may also be modified to create various magnitudes of countering force 210. For example, the length 317 of the arm portion 307 may influence the countering force 210 of the gasket.

The countering forces 210a and 210b hold the carrier 234 in place. The greater the force 210, the more rigid the carrier 234 (and thus the drive) becomes. Depending on the specific conditions, the magnitude of the countering force 210 may be different. For example, if the chassis 100 has fans near the carrier, a more rigid carrier may be desirable to prevent rotational vibration from impairing the operation of the hard drive. In other applications, a less rigid carrier may be preferred. The gasket can be modified or customized depending on operating frequency and natural frequency. Therefore, the characteristics of the gasket may be selected, depending upon the application for which the gasket will be used, and/or the stabilizing force required for each unique hard disk drive or other device.

Furthermore, in the above described embodiment, an electronic device or carrier may be located and constrained to the chassis of the computer system peripheral device bay without the use of fasteners or multiple parts. The ability to use the gaskets to reliably locate the sidewalls and to bear the weight of the installed electronic device and carrier eliminates the use of additional parts. Saving internal computer system space is a significant advantage because the sizes of computer systems are decreasing and the complexity of computer systems are increasing. Also, using fewer part decreases manufacturing complexity and increases speed of manufacturing. Also, because the gaskets provide a load bearing feature, the electronic device and carrier may be shipped installed in the bay of the computer system.

In one embodiment, the gasket features mate with snap or aperture features of a sidewall fastened thereto and are formed so as to provide static discharge and ground to an electronic device carrier when the electronic device carrier. That is, when the electronic device carrier is installed into the peripheral device bay of the computer system, a first gasket electrically contacts the electronic device carried by the carrier to wipe any electrostatic buildup, and a second gasket electrically contacts the electronic device to electrically connect the electronic device to the ground of the computer system. Such an embodiment improves protection from electromagnetic interference and radio frequency interference, and improves containment.

Although the present disclosure has been described in detail, it should be understood that various changes, substitutions, and alterations may be made hereto without departing from the spirit and the scope of the invention as defined by the appended claims.

What is claimed is:

1. A chassis for use in a computer peripheral device bay, comprising:
a sidewall having an aperture; and
a gasket connected to the sidewall, such that a portion of the gasket protrudes through the aperture into the device bay.

2. The chassis of claim 1, further comprising:
a carrier coupled to the chassis, the carrier having a location determined by the location of the gasket.

3. The chassis of claim 2, wherein the carrier holds an electronic device.

4. The chassis of claim 3, wherein the electronic device is a hard drive.

5. The chassis of claim 1, wherein:
the gasket is a first gasket;
the sidewall is a first sidewall; and
a second gasket is connected to a second sidewall having an aperture, such that a portion of the second gasket protrudes through the aperture of the second sidewall into the device bay.

6. The chassis of claim 5, further comprising:
a carrier coupled between the first and second gaskets.

7. The chassis of claim 6, wherein the carrier has an electronic device disposed therein.

8. The chassis of claim 7, wherein the electronic device is a hard drive.

9. The chassis of claim 1, wherein the gasket grounds an electronic device when the electronic device is installed in the chassis.

10. The chassis of claim 1, wherein the gasket discharges electrostatic buildup of an electronic device when the electronic device is installed in the chassis.

11. The chassis of claim 1, wherein the gasket exerts a force on an electronic device when the electronic device is installed in the chassis, said force causing the electronic device to resist movement.

12. The chassis of claim 1, wherein the gasket bears the weight of an electronic device when the electronic device is installed in the chassis.

13. A chassis for dampening vibration, comprising:
a sidewall having an aperture; and
a tuning gasket connected to the sidewall, such that a portion of the tuning gasket protrudes through the aperture into the device bay.

14. The chassis of claim 13, wherein
the tuning gasket is a first tuning gasket;
the sidewall is a first sidewall; and
a second tuning gasket is connected to a second sidewall having an aperture, such that a portion of the second tuning gasket protrudes through the aperture of the second sidewall into the device bay.

15. The chassis of claim 14, further comprising:
a carrier coupled to the chassis, the carrier having a location determined by the location of the tuning gaskets.

16. The chassis of claim 15, wherein:
the tuning gaskets exert a force on the carrier, said force causing the carrier to resist movement.

17. A method of grounding a peripheral device in a computer system, the method comprising:
providing a plurality of gaskets on an interior surface of the computer system; and
installing a peripheral device in the computer system.

18. The method of grounding of claim 17, wherein providing of the gaskets on the interior surface of the computer system comprises:
attaching each of the gaskets to a sidewall having an aperture, such that a portion of the gasket protrudes through the aperture into the device bay.

19. The method of grounding of claim 17, wherein installing the peripheral device in the computer system comprises:
electrically coupling a grounding contact of the peripheral device to at least one of the gaskets; and
locating the peripheral device in a position determined by a location of at least one of the gaskets.

20. The method of grounding of claim 17, the method further comprising:
supporting the weight of the peripheral device by the gaskets.
